(19) United States
(12) Patent Application Publication
(10) Pub. No.: US 2020/0102432 A1
(43) Pub. Date: Apr. 2, 2020

(54) FLAME-RESISTANT STRUCTURAL COMPOSITE MATERIAL

(71) Applicant: Cristiano BORDIGNON, Fiumicino(RM) (IT)

(72) Inventors: Cristiano BORDIGNON, Fiumicino (RM) (IT); Elena LANDI, Toscanella (BO) (IT); Valentina MEDRI, Faenza (IT); Annalisa NATALI MURRI, San Lazzaro di Savena (BO) (IT)

(73) Assignee: Cristiano BORDIGNON, Fiumicino (RM) (IT)

(21) Appl. No.: 16/497,808

(22) PCT Filed: Mar. 28, 2018
(86) PCT No.: PCT/IT2018/050054

§ 371 Date: Sep. 26, 2019

(30) Foreign Application Priority Data
Mar. 28, 2017 (IT) 102017000033960
Mar. 28, 2017 (IT) 102017000033972

(51) Int. Cl. C08J 5/10; C09K 21/02; C09K 5/14; C08K 3/34

(52) U.S. Cl. CPC C08J 5/10; B82Y 30/00; C09K 5/14; C08K 3/34; C08K 2201/011; C08K 2201/005; C08K 2201/006; C08K 2201/004; C08K 2201/003; C08K 2201/001; C08K 2003/343; C08J 2361/06; C08J 2379/08; C08J 2383/16; C08J 2363/00; C09K 21/02

(57) ABSTRACT

The present invention relates to a flame-resistant composite material, in particular a composite material comprising an inorganic matrix and an organic matrix.

The present invention also relates to the method of production of the organic matrix and to the organic matrix, which exhibits a particular resistance to oxidative environments.

Therefore, the composite material according to the present invention finds application where there is a strong oxidation, characteristic of high temperature environments, typically over 700° C., as heat-resistant material, of a fire barrier, or as a material for manufacturing all those artefacts. with operating temperatures between −55° C. and 1200° C. and, for example, with life cycle according to international aeronautical regulations.

### TECHNICAL FIELD OF THE INVENTION

The present invention relates to the field of materials technology, in particular materials resistant to high temperatures. The present invention therefore finds application in the various fields in which such materials are used, such as, for example, the aerospace, naval, automotive, railway and construction sectors in general or the electronics sector.

### STATE OF THE ART

As is well known, a composite material is a material consisting of several simple materials aggregated by means of a specific production method. Said composite materials have a non-homogeneous structure and have the purpose to merge in the same material at least a pair of materials having different physico-chemical properties and different mechanical capacities. The components (ie the base materials) of a composite material, are at least one reinforcement and at least one matrix.

The reinforcement (or filler) is represented by a dispersed phase that has the function of ensuring rigidity and mechanical strength, supporting most of the working load.

Generally, the matrix consists of a homogeneous phase having the function to enclose the reinforcement, ensuring the cohesion of the composite material and homogenizing the dispersion of the particles or fibers reinforcement inside the composite, avoiding segregation phenomena.

In most cases the matrices are polymeric because they guarantee low density and therefore lightness of the final material. However, they have the defect of drastically lowering the mechanical performance as the temperature increases.

There are some international patent applications filed to describe a composite material resistant to high temperatures, such as the US patent US2016340586, entitled “Fire resistant material”.

It concerns a flame retardant composite material for which the materials used and the respective proportions are clearly indicated.

Although the above mentioned patent effectively solves the problem of resistance to high temperatures, it is not as efficient from the point of view of weight, thickness, mechanical performance of the material and production costs.

There does not seem to exist, in the state of the art, a composite material consisting of at least one reinforcement and at least a double matrix, one organic and one inorganic.

Therefore, the object of the present invention is to propose a new and innovative composite material, having high structural performances, a reduced thickness and weight.

A further object of the present invention, which is part of the same inventive concept, is to propose a new and innovative inorganic matrix, and the relative production method, for the above mentioned composite material.

### SUMMARY OF THE INVENTION

Therefore, the technical problem posed and solved by the present invention is to provide a structural composite material which, in combination with high mechanical capacities, also associates a low weight and thickness, and a structural resistance to oxidation, characteristic of high temperature, for example over 700° C., environments.

This problem is solved by a method for obtaining an inorganic polymer-based matrix for a flame-resistant fibro-reinforced composite material, according to claim 1, from a matrix according to claims 5 and 9 and from a composite material, according to claim 13.

Preferred features of the present invention are detailed in the dependent claims.

The present invention provides some relevant advantages.

In particular, the characteristic mixture for obtaining the inorganic matrix, allows the possibility to use it in environments having high oxidative risk, for example at high temperature environments, preventing a structural deterioration.

Advantageously, the possibility to insert nanofillers having different nature within the above mentioned mixture, allows also to adjust a value of thermal conductivity of the inorganic matrix according to the required specific application.

A further advantage is that the production method of the matrix, according to the present invention, is quick and economical.

A still further advantage is that the composite material according to the present invention, having high mechanical capacities, has a contained weight and thickness and the thermal conductivity values can be adjusted according to the specific type of nanofiller used.

Other advantages, features and methods of use of the present invention will be clear from the following detailed description of some embodiments, presented by way of a non-limiting example.

### BRIEF DESCRIPTION OF THE FIGURES

The invention will be described below by at least one preferred embodiment for explanatory and non-limiting purposes with the support of the attached figures, wherein:

FIG. 1 shows the graph relating to a fire resistance test—performed according to the ISO 2685 international parameters—of an embodiment of the composite material according to the present invention;

FIG. 2 shows a scanned electron microscope (SEM) image of nano silicon carbide beta particles;

FIG. 3 shows a scanning electron microscope (SEM) image of hollow glass microspheres;

FIG. 4 shows a scanning electron microscope (SEM) image of a glass cavity microsphere revealing its empty structure;

FIG. 5 shows a scanning electron microscope (SEM) detail of a cutting section of a structural composite material having low thermal conductivity, made according to a first embodiment of the present invention, having a first inorganic matrix comprising polysialate with nano-powders dispersion of beta-silicon carbide and a second organic matrix inside which other nano-powders of beta-silicon carbide are dispersed;

FIG. 6 shows a scanning electron microscope (SEM) detail of a cutting section of a structural composite material according to a further embodiment according to the present invention, made by a first inorganic matrix consisting of a polysialate with hollow glass microspheres dispersion and a second organic matrix within which other hollow glass microspheres are dispersed;

FIG. 7 shows a scanned electron microscope (SEM) image of carbon nano-tubes;

FIG. 8 shows a scanning electron microscope (SEM) detail of a cutting section of a structural composite material according to a second embodiment of the present invention, made by a first inorganic matrix comprising polysialate with dispersion of carbon nano-tubes and a second organic matrix within which other carbon nano-tubes are dispersed;

FIG. 9 shows a diagram of the production process consisting of a first step of a first curing step (A), a second post-curing step (B), a third impregnation step (C), a fourth curing step (D) and a fifth post-curing step (E). The diagram also shows the possibility to repeat the cycle starting from the third impregnation step (C) according to the desired characteristics for the resulting material.

### DETAILED DESCRIPTION OF PREFERRED EMBODIMENTS

The present invention will now be illustrated purely by way of non-limiting example, or by restricting it, using the figures which illustrate some embodiments in relation to the present inventive concept.

The object of the present invention relates to the method for obtaining an inorganic matrix, to the inorganic matrix and to a composite comprising reinforcing fibers, a first inorganic matrix and a second organic matrix.

Advantageously, this composite, characterized by the combination of inorganic resins with organic resins, both nano-structured, is applied where there is a strong oxidation, characteristic of high temperature environments, typically over 700° C., as heat-resistant, fire-resistant material, or as a material to manufacture all those products having operating temperatures between −55° C. and 1200° C. and having a life cycle responding to the international aeronautical standards.

The composite material, object of the present invention, extends in a significant and extremely advantageous way the application field of the composite materials, without significantly increasing the costs and using the equipment typically used for the conventional composites, such as carbon molds having polymeric, or glass fiber, matrices made by aluminum alloy or steel.

Advantageously, said reinforcement consists of any fibrous material, for example basalt fiber, glass fiber—in particular, E, S or R glass—metal meshes, even more preferably carbon fiber.

Advantageously, said inorganic matrix comprises an alkaline polysialate, water-based, inorganic polymer. The matrix is advantageously nano-structured, in particular comprising nano-powders of beta silicon carbide, or hollow glass microspheres, or carbon nanotubes.

The primary role of said first inorganic matrix is to allow a resistance to very high temperatures due to its property to protect the fiber reinforcement against the oxidations typical of temperatures higher than 700° C.

Said first inorganic matrix is preferably a nano-composite polysialate matrix and is obtained by mixing an alkaline earth silicate component comprised in the group of cesium, sodium or, more preferably potassium, in a percentage by weight (% wt) between 40 wt % and 60 wt %, with an amorphous silica component and/or an aluminosilicate reactive powder.

The amorphous silica component may be thermal silica, fused silica or pyrogenic silica having an average particle size comprised between 0.01 μm and 15 μm.

The amorphous aluminosilicate component is in particular stoichiometrically controlled by an Al₂O₃×2SiO₂ composition and a total amount lower than 6% of oxides other than SiO₂ and Al₂O₃.

The main molar ratios of the polysialate resin thus obtained are comprised within the following ranges:
SiO₂:Al₂O₃=60.9-215
M₂O:SiO₂=0.08-0.40 where M is an alkaline earth metal cation chosen between Na, Cs or K
M₂O:Al₂O₃=8.0-50 where M is an alkaline earth metal cation selected between Na, Cs or K
H₂O:K₂O=10.0-28

Moreover, the above mentioned alkaline polysialate matrix contains a charge having a nanometric size.

Preferably, the production method of the inorganic matrix according to the present invention comprises an ultrasonic mixing process of the charged mixture, so as to allow a homogeneity of the nanocaricles dispersion within the mixture.

Advantageously, as will be better described in the following, the nature of the specific nanocharge inserted in the mixture, determines a specific thermal conductivity value of the obtained inorganic matrix.

The addition of nanoparticles, in particular when homogeneously distributed, also improves the mechanical strength of the invention.

A first embodiment of the matrix according to the present invention comprises a nanometric powder, or nano particles, of silicon beta carbide having a dimension comprised between 50 nm and 950 nm and an average specific surface comprised between 10 m²/gr and 60 m²/gr, preferably between 40 m²/gr and 50 m²/gr.

Said nano powder is added, in an amount comprised between 0.5 wt % to 15 wt %, to the polysialate matrix, in order to form said first inorganic composite matrix.

Preferably, the percentage in weight of said nano silicon beta carbide particles is comprised between 1 wt % and 10 wt %. In particular, at a percentage of about 2.60 wt %, the matrix according to the first embodiment of the invention here described has a thermal conductivity value of about 0.9 W/mK at about 1200° C.

The matrix filled by silicon carbide beta nanoparticles is therefore characterized by a low thermal conductivity value.

A further embodiment of the matrix here described provides the use of hollow glass nanoparticles to be added to the mixture to allow a regulation of the porosity during the processing of the polymeric material.

A second embodiment of the inorganic matrix obtaining method according to the present invention, provides for the use of carbon nanotubes.

Preferably, the carbon nanotubes have an average diameter of 1 nm, an average length of 1.5 μm and an average specific surface comprised between 250 m²/gr and 500 m²/gr.

In the example here described, the percentage of said nanotubes is comprised between 0.1 wt % and 5 wt %.

In particular, at a percentage of about 0.50 wt %, the matrix according to the second embodiment of the invention here described has a thermal conductivity value of about 0.31 W/mK at about 1200° C.

The matrix filled by carbon nanotubes is therefore characterized by a high thermal conductivity value. This conductivity value increases according to the orientation degree of the nanotubes into the matrix.

In order to obtain the optimization of the ratio between specific weight and resistance, the composite material according to the present invention is also advantageously provided with a second organic matrix, which is also nano-structured.

Said second organic matrix, preferably phenolic, bismaleimidic, polysilazanate, epoxy or cyanate esters, advantageously provides the structural characteristics to the final composite material and regulates the porosity, in particular allows a reduction of the porosity of the material allowing an improvement of the reaction characteristics over liquids and gases.

The nano-structure of both matrices by means of beta silicon carbide nano-powders of hollow glass micro-spheres, is preferable and advantageous, since they perform the dual function of determining the porosity and contributing to the improvement of the material's life cycle, especially at very high temperatures, also improving the matrix-reinforcing fiber interface.

Preferably, the percentage of reinforcing fibers of the composite material according to the present invention is comprised between 54 wt % and 64 wt %.

Once the preliminary composite material (so-called pre-impregnated) has been obtained, i.e. consisting in the reinforcement and the first inorganic matrix, the following production steps are provided for obtaining the structural composite material according to the present invention:

(A) a first curing step, made in an autoclave or under a press with pressure values comprised between 1 bar and 10 bar, or at a normal atmospheric pressure, with temperatures comprised between 40° C. and 80° C.; said first curing phase may possibly take place in a vacuum;
(B) a second post-curing step, wherein the material is heating at temperatures comprised between 100° C. and 900° C.; the material resulting from this second post-curing step having a porosity comprised between 20% and 30%;
(C) a third impregnation step, carried out at controlled pressure value or by an immersion of the material resulting from the preceding second post-curing step in said second organic matrix;
(D) a fourth curing step in which the material is worked according to the known techniques based on of the specific resin constituting said second organic matrix; (E) a fifth post-curing step, wherein the material resulting from the preceding fourth curing step is heating at temperatures values comprised between 250° C. and 900° C. (for nanofillers comprising silicon beta carbide nanoparticles) or comprised between 400° C. and 900° C. (for nanofillers comprising carbon nanotubes), possibly in an inert gas atmosphere, for example nitrogen.

Advantageously, said third impregnation step, fourth curing step and fifth post-curing step can be repeated the desired number of times until the desired porosity, comprised between 2% and 30%, is obtained.

Preferably, the above mentioned steps are repeated at least twice.

In order to obtain final very low values of the porosity of the final material, until to a minimum value of 2%, said third impregnation step C, said fourth curing step D and said fifth step of post-curing, can be repeated cyclically.

Due to the materials used and to the obtaining method, the above mentioned structural composite material has characteristics that make it particularly suitable for the construction of structural components intended for environments with temperatures comprised between −55° C. and 1200° C. or any environment characterized by a strong oxidation.

In case of beta-silicon carbide nano-powders are used in the two matrices, both said first inorganic matrix and said second organic matrix, the percentage of said beta-silicon carbide nano-powders varies between 0.5% and 15% while their surface area varies between 10 m²/gr and 60 m²/gr.

The structural composite material according to the present invention advantageously has a density value comprised between 1.2 gr/cm³ and 1.4 gr/cm³, preferably 1.25 gr/cm³ and therefore a specific weight comprised between 1.20 g/cm³ and 1.35 gr/cm³.

In particular, the tensile strength of the composite material according to the present invention is advantageously comprised between 150 MPa and 250 MPa.

The firing resistance of the material thus obtained is one of the characteristics that make it particularly advantageous.

In fact, after being subjected to a fire event, it presents a strength substantially identical to the strength before exposure to the flame.

Moreover, it is advantageously resistant to the passing flame and does not emit fumes or vapors when exposed to fire.

The advantages offered by the present invention are evident considering the description above mentioned and will be even clearer in view of the attached figures, relating in particular to some embodiments of the invention according to the present invention.

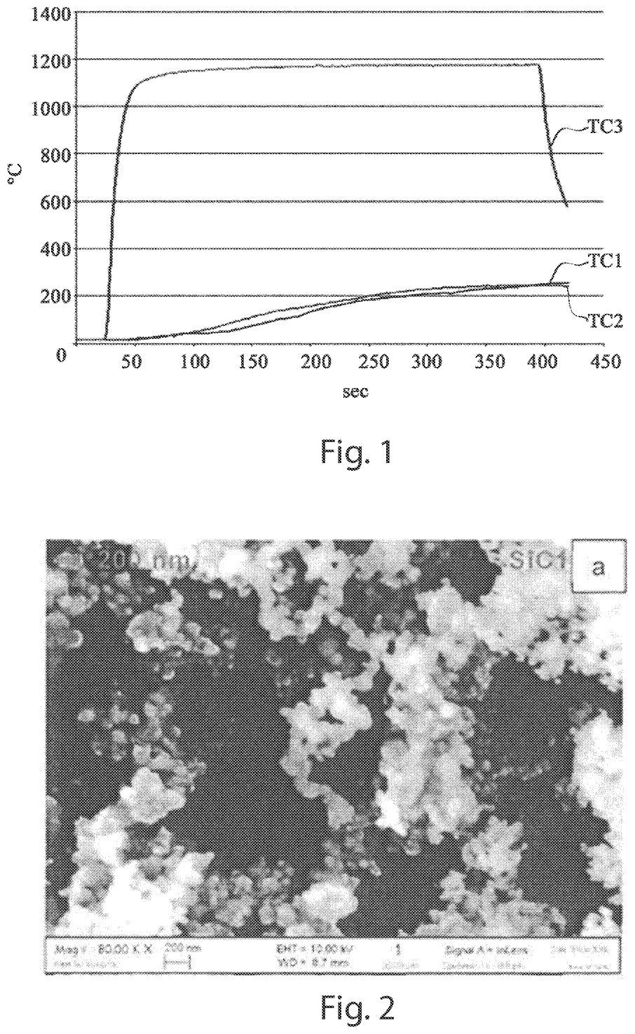

With reference to FIG. 1, a graph is shown relating to a firing resistance test of an embodiment of the composite material according to the present invention, performed according to the ISO 2685 international parameters. In particular, the curve TC1 represents the temperature values of the hot part exposed to the flame; the curve TC2, instead, shows the data relative to the opposite side, that is the cold one, not exposed to the flame; finally, the curve TC3 illustrates the temperature values recorded on the cold side.

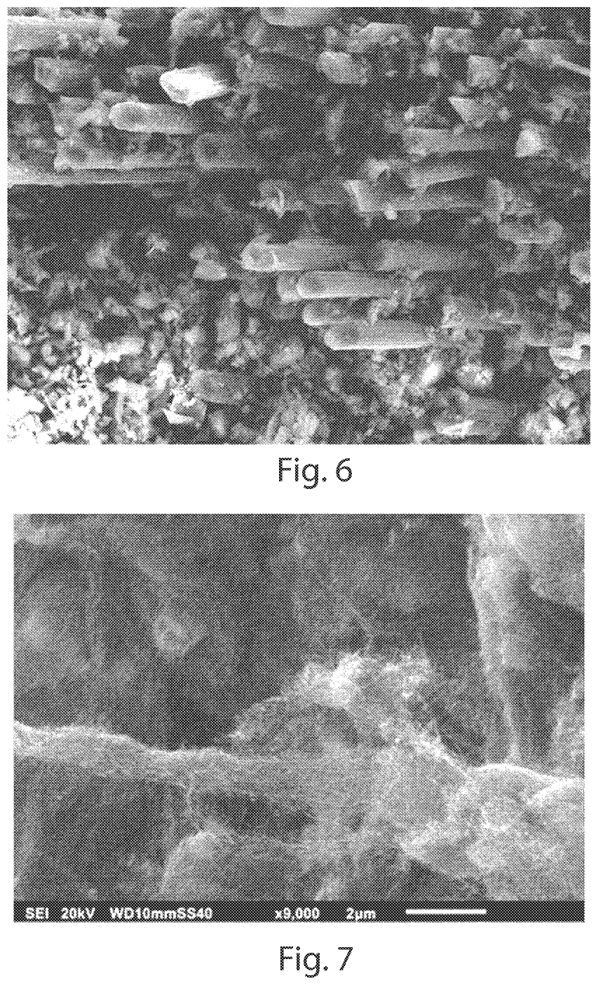

FIG. 5 shows a scanning electron microscope (SEM) detail of a cutting section of a structural composite material having a low thermal conductivity value, made according to a first embodiment of the present invention, with a first inorganic matrix comprising polysialate with dispersion of beta-silicon carbide nano-powders and a second organic matrix inside which other beta-silicon carbide nano-powders are dispersed.

Said material consists of the reinforcing fiber impregnated with said first inorganic matrix constituted by polysialate with dispersion of beta silicon carbide nano-powders. Into this matrix said second organic matrix is added, inside which other beta silicon carbide nano-powders are dispersed.

The composite material thus obtained guarantees a very high number of cycles at temperatures up to 1200° C. and has the following structural characteristics:
Tensile strength=150 MPa
Elastic module=52 GPa
Compressive strength=34 MPa
Flexural strength=70 MPa
Thermal conductivity=0.24 W/mK
Porosity=15%
Density=1250 Kg/m³

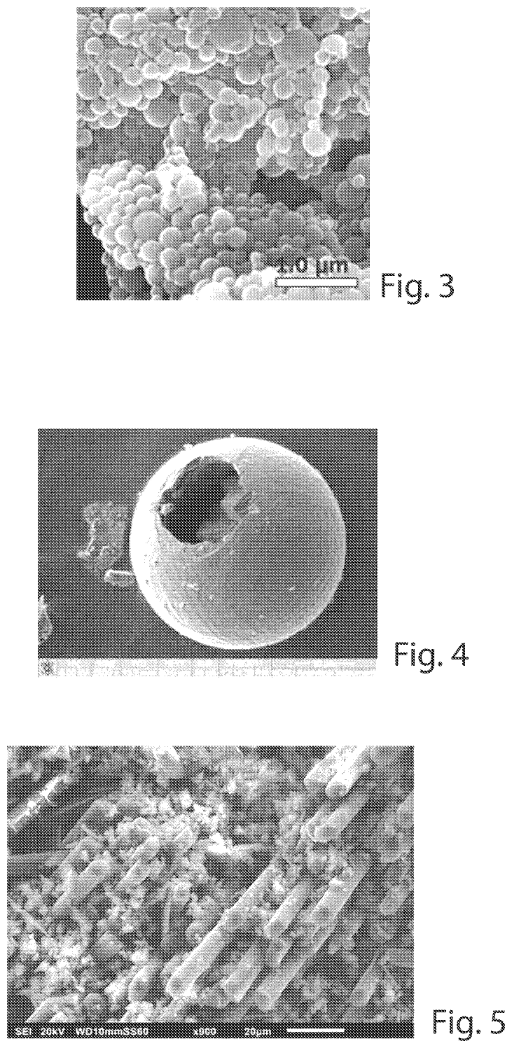

With reference to FIG. 3, an image is shown, by scanning electron microscope (SEM), of the fibers relating to a further preferred embodiment of the structural composite material with low thermal conductivity, object of the present invention.

Said material consists of the reinforcing fiber impregnated with said first inorganic matrix consisting of polysialate with dispersion of hollow glass microspheres.

Said second organic matrix within which other hollow glass microspheres are dispersed, is added to the above mentioned first inorganic matrix.

The composite material thus obtained advantageously has very low values of thermal conductivity.

Its properties can be summarized in the following:
Tensile strength=150 MPa
Elastic module=52 GPa
Compressive strength=38 MPa
Flexural strength=70 MPa
Thermal conductivity=0.10 W/mK
Porosity=10%
Density=1300 Kg/m³

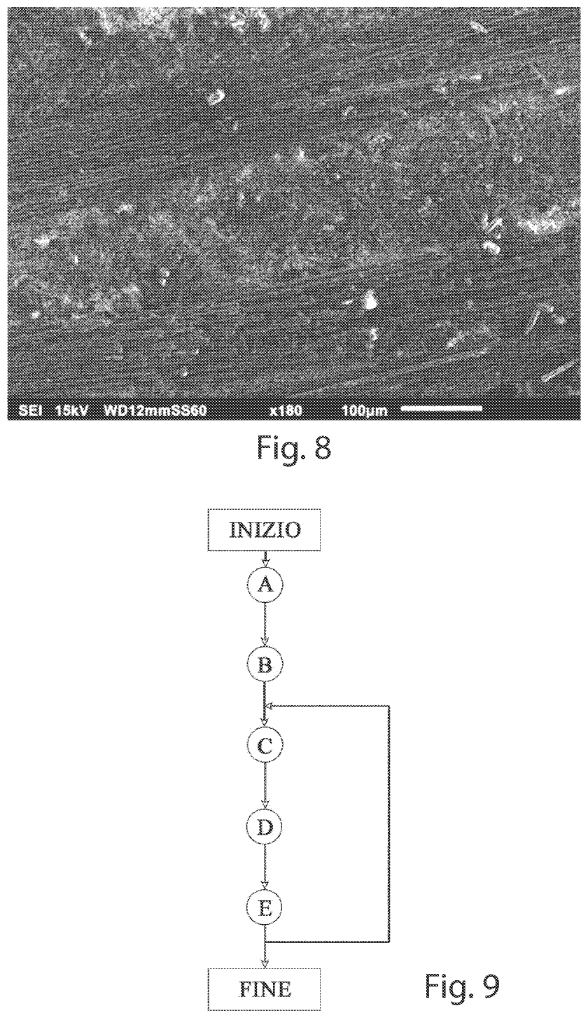

With reference to FIG. 8, an image is shown, by scanning electron microscope (SEM), of the cutting section of the structural composite material having high thermal conductivity, according to the second embodiment of the present invention.

Said material consists of the reinforcing fiber impregnated with said first inorganic matrix consisting of polysialate with dispersion of carbon nano-tubes.

The second organic matrix in which are dispersed other carbon nano-tubes, is added to this material.

The composite material thus obtained guarantees a very high number of cycles at temperatures up to 1200° C. and has the following structural characteristics:
Tensile strength=160 MPa
Elastic module=42 GPa
Compressive strength=72 MPa
Flexural strength=95 MPa
Thermal conductivity=40 W/mK
Porosity=2%
Density=1350 Kg/m³

In more general terms, to better define the scope of protection offered by the attached claims, the low thermal conductivity structural composite material, object of the present invention, is composed at least of:
a reinforcing fiber, comprising any fibrous material, preferably basalt fiber, glass fiber E, glass fiber S, glass fiber R, metal meshes, even more preferably carbon fiber. More in detail, regardless of which type of fiber is used, said reinforcing fiber must be present in a percentage by weight of the composite material, comprised between 54 wt % and 64 wt %;
a first inorganic matrix, consisting of an original inorganic water-based nano-structured polymer, having beta silicon carbide nano-powders or hollow glass microspheres in a percentage comprised between 0.5 wt % and 15 wt %;
a second organic matrix, comprising a resin selected from a group of phenolic, bismaleimidic, epoxy, cyanate esters, polyisylazanates also nano-structured with silicon beta carbide nano-powders or with hollow glass microspheres; said second organic matrix being able to determine a porosity of the composite material comprised between 2 wt % and 30 wt %.

In more general terms, to better define the scope of protection offered by the annexed claims, the structural composite material according to the described second embodiment, with a high thermal conductivity, consists of at least:
a reinforcing fiber, consisting of any fibrous material, preferably basalt fiber, glass fiber E, glass fiber S, glass fiber R, metal meshes, even more preferably carbon fiber.

More in detail, regardless of which type of fiber is used, said reinforcing fiber must be present in a percentage by weight comprised between 54 wt % and 64 wt % of the composite material;
a first inorganic matrix, consisting of an original aqueous base nano-structured inorganic polymer having carbon nano-tubes, in a percentage by weight comprised between 0.5% wt and 8% wt.

The material with which said first inorganic matrix is nano-structured provides a decrease of the material porosity, bringing it to a value comprised between 20% and 30%, and to obtain the desired thermal conductivity;
a nano-structured second organic matrix, consisting of a phenolic resin, polysilazanates, bismaleimidic, epoxy, cyanate esters, having carbon nano-tubes; said second organic matrix being able to determine a porosity of the composite material comprised between 2% and 20%.

Advantageously, the conductivity degree of a laminar element made by the material according to the present invention is maximized by orientating the nanotubes along a thickness of the element, in particular by applying a magnetic field during the construction of the article. For example, an orientation of both the nanotubes present in the inorganic and in the organic matrix can be provided. In particular, the nanotubes can be oriented both during the realization phase of the pre-impregnated, and during the realization phase of the composite, or at viscosity values of the material (respectively of the first inorganic matrix and of the organic matrix) which allow this orientation through the application of a magnetic field.

In particular, at a complete orientation of the nanotubes along an axis identifying a thickness of the laminar element, the thermal conductivity of the invention can reach values over 80 W/mK, for example of 90 W/mK, in a temperature range comprised between 20° C. and 250° C.

Advantageously, the composite material thus obtained has a specific weight of 1.25 gr/cm³, a tensile strength value of 200 MPa and an elastic modulus of 36 GPa.

The mechanical and structural characteristics of the composite material according to the present invention, make it resistant to the passing flame, smoking-proof, vapor-proof and, above all, do not vary even if exposed to fire.

In particular, the composite material according to the present invention allows the realization of lamellar fire barrier elements characterized by a thickness of about 0.4 mm.

More in detail, for example, two skins of impregnated carbon fiber of 200 gr/m² having percentages comprised between 54% and 64% by weight of reinforcing material, are sufficient to generate a thermal shield resistant to a flame with a temperature of 1.200° C. and a thermal flow up to 150 KW/m².

The weight of the composite material having flame-retardant shield functions according to the present invention is extremely reduced, in particular it is equal to 500 gr/m².

No material of the prior art allows, with such a reduced weight, the containment of a flame with a temperature of 1.200° C. and a thermal flow over 120 KW/m². For example, titanium alloys are able to contain the flame with thicknesses of about 0.5 mm but have a weight of over 2000 gr/m².

Even the ceramic matrix composites succeed in this purpose but they have weights of about 800 gr/m² and therefore always higher than the invention according to the present invention. No material with such specific weight, has tensile strength characteristics of about 200 MPa and an elastic modulus of about 30 GPa.

In addition to the very high mechanical and structural performances, the material object of the present invention does not present high production costs, as the previously illustrated production process uses equipment commonly used for any composite material currently available on the market such as, for example: carbon molds having polymeric or glass fiber matrices or aluminum alloy or steel.

Advantageously, moreover, it will be possible to obtain components having complex shapes through a single piece, avoiding costly additional mechanical machining.

Finally, it is clear that modifications, additions or obvious variations may be made to the invention here described by a person skilled in the art, without thereby departing from the scope of protection provided by the attached claims.

The present invention has been described by way of illustration, but not of limitation, according to its preferred embodiments, but it is to be understood that variations and/or modifications may be made by persons skilled in the art without departing from the relative scope of protection, as defined by the attached claims.

1. Method for obtaining an inorganic polymer-based matrix for a flame-resistant fibro-reinforced composite material, said method comprising a step of making a mixture having an alkaline earth silicate component comprised in the group of cesium group (Cs.), sodium (Na) or potassium (K), said silicate component being in a percentage by weight comprised between 40% and 60%, a component of amorphous silica, and an amorphous aluminosilicate component,
wherein the molar ratios of said components are comprised in the ranges:
SiO₂:Al₂O₃=60.9-215,
M₂O:SiO_{2=0.08}-0.40, wherein M is an alkaline earth metal cation chosen between the Na, Cs or K, above mentioned,
M₂O:Al₂O₃=8.0-50, wherein M is an alkaline earth metal cation selected between Na, Cs or K,
H₂O:K₂O=10.0-28,
said mixture further comprising a percentage by weight of filler having a nanometric dimension, said charge being configured to define a thermal conductivity value of said mixture.

2. Method according to claim 1, comprising an ultrasonic mixing step of said mixture.

3. Method according to claim 1, wherein said amorphous silica component, comprising thermal silica, fused silica or pyrogenic silica, has particles having average size from 0.01 μm to 15 μm.

4. Method according to claim 1, wherein said amorphous aluminosilicate component is stoichiometrically controlled by an Al₂O₃×2SiO₂ composition and a total amounts of oxides other than SiO₂ and Al₂O₃ lower than 6%.

5. An inorganic polymer-based matrix, for a flame-resistant fibro-reinforced composite material, obtained or obtainable by the method according to claim 1, wherein said filler comprises beta silicon carbide nano-particles.

6. Inorganic matrix according to claim 5, wherein said beta silicon carbide nano-particles have a dimension comprised between 50 nm and 950 nm and an average specific surface comprised between 10 m²/gr and 60 m²/gr, optionally comprised between 40 m²/gr and 50 m²/gr.

7. Inorganic matrix according to claim 6, wherein the percentage by weight of said beta silicon carbide nano particles is comprised between 1% and 10%.

8. Matrix according to claim 7, wherein said percentage by weight of said beta silicon carbide nano particles is equal to about 2.60%, characterized by a thermal conductivity value of about 0.9 W/mk at 1200° C.

9. An inorganic polymer-based matrix, for a flame-resistant fibro-reinforced composite material, obtained or obtainable by the method according to claim 1, wherein said filler comprises carbon nano-tubes.

10. Inorganic matrix according to claim 9, wherein said nanotubes have an average diameter of about 1 nm, an average length of about 1.5 μm and an average specific surface comprised between about 250 m²/gr and 500 m²/gr.

11. Inorganic matrix according to claim 10, in which a percentage by weight of said nanotubes is preferably comprised between a value of 0.1% and 5%.

12. Inorganic matrix according to claim 11, wherein said percentage by weight of said nanotubes is equal to about 0.50%, characterized by a thermal conductivity value of about 0.3 W/mK at 1200° C.

13. Fiber-reinforced, flame-resistant composite material, comprising:
a reinforcing fiber selected in a group of carbon fiber, basalt fiber, glass fiber, said reinforcing fiber being in a percentage comprised between 54% and 64% by weight of the composite material;
an inorganic matrix obtained or obtainable by the method according to claim 1;
an organic matrix comprising a resin selected in a group of phenolic, bismaleimidic, polysilazanate, epoxy or cyanate esters, and a charge, substantially identical to the charge present in said inorganic matrix, having a nanometric size;
characterized in that said second organic matrix is inserted by impregnation into a plurality of pores of said inorganic matrix, said second organic matrix being adapted to reduce a residual porosity of the composite material, said reduction of the residual porosity being dependent on the number of said operations impregnation.

14. Composite material according to claim 13, wherein said fillers of said inorganic matrix and of said organic matrix are beta silicon carbide nano-particles, characterized in that having a porosity comprised between 2% and 30%.

15. Composite material according to claim 14, characterized in that, at a residual porosity of about 15%, it has a thermal conductivity of about 0.24 W/mK at 1.200° C.

16. Composite material according to claim 13, wherein said fillers, of said inorganic matrix and said organic matrix, are carbon nanotubes, characterized in that they have a residual porosity comprised between 2% and 20%.

17. Composite material according to claim 16, characterized in that, at a residual porosity of about 2%, it has a thermal conductivity of about 40 W/mK at about 1200° C.

18. Composite material according to claim 16, wherein said nanotubes are oriented along a same main axis.

19. Composite material according to claim 18, characterized by a thermal conductivity value equal to about 90 w/mK in a temperature range comprised between 20° C. and 250° C., said material comprising a specific weight of 1.25 gr/cm3, a tensile strength value of about 200 MPa and an elastic modulus of about 36 GPa.
